(19) United States
(12) Patent Application Publication
(10) Pub. No.: US 2005/0137990 A1
(43) Pub. Date: Jun. 23, 2005

(54) Method for sending postal packets

(76) Inventors: Boris Mayer, Bonn (DE); Steffen Frankenberg, Koln (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/820,598

(22) Filed: Apr. 8, 2004

Related U.S. Application Data
(63) Continuation of application No. PCT/DE02/03759, filed on Oct. 7, 2002.

(30) Foreign Application Priority Data
Oct. 9, 2001 (DE) 101 49 621.4

(51) Int. Cl. G06F 17/60

(52) U.S. Cl. 705/410

(57) ABSTRACT

Disclosed herein is a method for sending postal packets. A provisional destination address is input for distribution of a postal packet, the address capable of being modified after it has been input. An addressee identification code can be allocated to the addressee. The code is capable of being combined with the desired modifiable destination address.

### CROSS-REFERENCE TO RELATED APPLICATIONS

This is a continuation of International Application No. PCT/DE02/03759 filed Oct. 7, 2002, the disclosure of which is incorporated herein by reference.

### BACKGROUND OF THE DISCLOSURE

1. Field of the Disclosure

The disclosure generally relates to a method and device for dispatching postal parcels.

2. Brief Description of Related Technology

EP 1 053 798 A2 discloses a virtual post office box. The physically non-existent post office box can be rented by persons and is linked to the address of these persons. Postal parcels that are addressed to the virtual post office box are segregated from the sorting process and forwarded to the address of the renter. The renter can indicate the period of time during which the postal parcels are to be forwarded to a given address. By the same token, he can change this address by sending a notification to this effect to the postal service company.

U.S. Pat. No. 6,269,369 B1 describes a network-based contact manager with which selected address information of a first user can be made accessible to a second user. Changes in the address data of the first user are sent to the second user, and the address data are then updated in the address book of the second user.

With the known dispatching methods, the problem exists that the recipient of the shipment often cannot be reached at the time of the delivery. This is especially a drawback in delivering postal parcels that cannot be placed into conventional mailboxes.

### SUMMARY OF THE DISCLOSURE

Disclosed herein is a postal parcels delivery method that is fast, reliable, and involves as little dispatching effort as possible. Accordingly, the method includes inputting a delivery address for the delivery of the postal parcels, and changing the delivery address according to one or more of a routine predefined by the recipient and a function of free compartments of at least one parcel compartment system. The method also includes delivering the postal parcels to the changed delivery address. The disclosed method allows a flexible delivery of postal parcels, and provides a flexible control of the dispatching process. Preferably, the desired delivery address here is treated like a virtual delivery address that can be changed as a function of the requirements of the customer or of the postal service company.

Additional features of the disclosed method may become apparent to those skilled in the art from a review of the following detailed description, taken in conjunction with the appended claims.

### DETAILED DESCRIPTION

In order to combine great flexibility of the dispatching of the postal parcels with high reliability of the delivery, the delivery address and the time of the delivery are advantageously selected in such a way that the postal parcels reach the desired delivery location within a predefined delivery period and in that, within this prescribed delivery period, the delivery to the desired delivery address takes place under the anticipated dispatching sequence of the postal parcel.

The link between the recipient identification code and the delivery address can be freely changed and this can also be done according to a predefined procedure. A variable link between the recipient identification code and the delivery address translates into maximum flexibility for the postal service company as well as for the sender and for the recipient of the postal parcel. For example, in this manner, negotiation documents can be sent to a business person at the location where the negotiations are being held, or spare materials or special tools can be sent to a service technician at the place of use or to a delivery point located close to the place of use.

A change in accordance with a predefined routine is likewise advantageous. For example, a recipient might prefer to receive a delivery at his workplace during regular business hours, but might prefer the delivery to an electronic parcel compartment system while he is on his way home or else he might prefer the delivery to his home address after returning from work. A stored table containing the allocation of delivery times and delivery places allows the postal service company to make the delivery to the place desired by the recipient in each case.

The above-mentioned example of the delivery to an electronic parcel compartment system is another preferred example showing the execution of the method. Such a delivery to the electronic parcel compartment system is especially advantageous if it is to be expected that the recipient of the postal parcel does not want the postal parcel to be delivered to his home or workplace at the anticipated delivery time or else if he does not want such a delivery modality as a general rule. For example, all postal parcels or all postal parcels with a definable and changeable delivery interval can be delivered to the electronic parcel compartment system. For the postal service company, this eliminates the effort involved in a failed delivery attempt to an unwanted delivery address, including the logistic effort associated with this for storing or holding the postal parcel or else for attempting delivery again.

The use of the method entailing delivery to an electronic parcel compartment system is likewise advantageous for the customer of the postal service company since this saves him unnecessary trips to pick up postal parcels and he receives the postal parcel at the earliest possible point in time.

In the case of delivery to an electronic parcel compartment system, the flexibility of selecting the delivery location is especially advantageous. In this manner, especially a flexible allocation of individual electronic parcel compartment systems, or individual postal boxes, is possible.

In particular, the disclosed method can be used to flexibly deploy the electronic parcel compartment systems, or the parcel compartments contained therein. This makes it possible to provide especially recipient-friendly, pick-up periods that optionally cover a longer period of time and, if a postal parcel is picked up from the parcel compartment assigned to it, then—immediately after this postal parcel has been picked up—another postal parcel can be placed into the parcel compartment that has just become free.

The flexible selection of several potentially deployable electronic parcel compartment systems is another advantage for the customer. Thanks to the flexibility of the method used, this advantage for the customer can be utilized with relatively little effort by a logistic company executing the method.

The method allows the use of various modalities of delivery and forwarding. For example, when the customer of a merchant places an order, he indicates his postal number (customer number for this service) as well as a delivery location (parcel compartment system) for the delivery of the ordered products.

The post number contains a check digit so that the correctness can be checked.

The recipient identification code can be issued individually for each order and it can also be used for multiple orders. In the first step, the system tracks the issuing of a post number for each customer. However, it is also conceivable that, for each transaction, a number is issued that provides authorization to use the system. It is especially advantageous for the postal service company to assign a fixed recipient identification code to a customer of the postal service company.

The delivery address can refer to the entire parcel compartment system (as well as to the individual parcel compartment). Both definitions of the delivery address are included. The disclosed method can be adapted to the delivery address that is used in each case.

Addressing

When the recipient places his order with the merchant, he provides his billing address as well as an alternative delivery address. The address of the desired PACKSTATION (PACKSTATION address) is indicated in the delivery address. For purposes of unambiguously identifying the shipment as a PACKSTATION delivery and for identifying the customer, the post number has to be indicated, also in the delivery address. The PACKSTATION address is a customer-individual automat address or branch office address to which deliveries can be made. Preferably, the address consists of the following: post number, PACKSTATION and number, actual postal code, and city.

The addressing of the alternative delivery possibility is shown below by way of an example:

| | |
|---|---|
| First name, last name | John Doe or Doe 123456789 |
| Second name field | 123456789 |
| Street, house number | PACKSTATION 102PACKSTATION 102 |
| Postal code, city | 53113 Bonn 53113 Bonn |

If possible, the house number is selected in such a way that no same house numbers/automat numbers are issued to adjacent postal code regions. Furthermore, the house numbers are three-digit numbers, and are divided into two fields, so that an unambiguous allocation of the automat and the branch office is ensured. The house number range is defined as 001-499 for automats and as 500-999 for branch offices. An automat in a branch office is designated and addressed as an automat. The numbering of the automats/branch offices is not done separately for each postal code, but rather according to defined postal code regions, for example, 53 or the city area of Bonn, that is to say, in a postal code district, here in the 53 district, the house numbers are issued consecutively on an overarching basis. Adjacent postal codes start with a different numbering.

The numbering is done according to PACKSTATIONS, as shown below, for examle. These are especially parcel compartment systems or branch offices that are integrated into the logistic system and that serve for picking up the parcels.

| | | | |
|---|---|---|---|
| 53113 | 53152 | 53114 | 53110 |
| PACK- | PACK- | PACK- | PACK- |
| STATION 1 | STATION 2 | STATION 3 | STATION 4 |

| | | |
|---|---|---|
| . . . | 54025 | 54320 . . . |
| . . . | PACKSTATION 101 | PACKSTATION 102 . . . |

Advantages of this form of addressing include, but are not limited to, expressive street names, better marketing possibilities, higher customer acceptance, the customer does not have to register separately for each automat, the geographic “postal code system” is retained, and no problems due to distortion of competition. Furthermore, the customer preferably has only one post number for all alternative delivery options. The post number is preferably, for instance, a 10 digit number that is assigned to a customer and that identifies him. Preferably, it is part of the delivery address as a suffix to the name. Disadvantages of this form of addressing include, more manual work for the in-house personnel, senders have to be thoroughly informed, and the transmission of the post number is secured.

The following table contains a presentation of preferred process steps.

Process

| No. | Process step | Prerequisites | Benefit | Remarks |
|---|---|---|---|---|
| 1. | Address entry | Entering the post | | According to the postal |
| | during the order | number in the | | address standard, a second |
| | placement | ordering process | | name field must be present. |
| | | | | Provision of the check |
| | | | | algorithm for the post number. |
| 2. | Gluing on the | Printing option for | Senders without | By updating the LOS file, this |
| | parcel label by the | the label with the | master coding do | point can be improved in the |
| | sender | post number in the | not have to handle | future. Due to the product |
| | | address field, | PACKSTATION | status as a PACKSTATION |
| | | sender cannot print | parcels separately. | product, this can/will also be |
| | | a master code | | covered by the SW shipment. |
| 3. | Transfer of the | | | Standard process |
| | shipments to | | | |
| | DPAG | | | |
| 4. | Master coding in | Update of the LOS | | The update of the LOS file for |
| | the sender's PZ | file (post-internal) | | internal processing (PZ) can |
| | | | | be realized up until the test |
| | | | | phase. |
| 5. | Sorting in the | Separate chute | Negative | |
| | freight center | (B-final places) | elimination of the | |
| | | | PACKSTATION | |
| | | | shipments, easier | |
| | | | escalation | |
| | | | possibilities | |
| 6. | Reworking in | Training the in- | Entering the post | The post number should be |
| | delivery basis | house personnel, | number can be | applied onto the parcel by the |
| | (coding of the | providing the | dispensed with for | in-house personnel as a |
| | customer number) | SW/HW | the delivery; reduction | barcode sticker; by means of |
| | | prerequisites | of the potential | a product identification |
| | | | for errors; simpler | (product code), this can be |
| | | | loading of the | done by the shipment SW; all |
| | | | automat on site | information can also be |
| | | | | integrated into the NC2001 |
| | | | | (going-live not confirmed |
| | | | | yet)?? |
| 7. | Delivery | | Scanning the post | |
| | | | number; shorter | |
| | | | loading times; | |
| | | | correct time | |
| | | | measurement | |
| 8. | Return shipments | | Correct time measurement | |
| | (retention time) | | | |
| 9. | Standard process; | Standard | | |
| | return shipment | | | |

Sequence Prerequisites

The sender has the possibility to accept and to activate an alternative delivery address and optimally an additional address line in his systems on the order form.

An automatic check of the delivery address, for example, in the on-line shop, in the goods management system or in the shipping logistic system, would have to be switched off, or would have to accept PACKSTATION addresses. The recipient has to know the PACKSTATION address and enter it himself. The post number should be indicated in the delivery address (=addressing of the parcel).

The prerequisites for the integration of an especially preferred embodiment are: defining the street designation; updating the LOS file; informing the central group BDV/LOS about the locations of the alternative delivery options; and, transmitting the post number from the ordering party via the sender to the local postal service provider (e.g., Deutsche Post AG).

In order to be able to realize a correct addressing of a print order (fax, letter) at post points, it is often necessary to implement a field for an alternative delivery address.

Data to be acquired/transferred

The most important information is the correct delivery address with: the post number; last name, optionally first name (if sufficient space available); street and number of the desired PACKSTATION; postal code and city of the desired PACKSTATION; and, the post number entered into the delivery basis by the in-house personnel.

The examples presented show preferred embodiments of the method for sending postal parcels.

Thanks to the transition from the first-selected provisional delivery address to the final delivery address, a flexible sending of the postal parcels to the recipient in question can be realized. This also makes it possible for the recipient to designate other persons as the recipient. For example, a customer who is unable to receive a parcel or to pick it up from an electronic parcel compartment system can inform a server that is centrally integrated into the process—preferably a web server—about another person as the recipient by entering identifying information about said person, if possible, in encrypted form. In this manner, another person rather than the originally designated recipient can retrieve a parcel from an electronic parcel compartment system during a prescribed time period without there being a need for the other recipient to know the customer identification information of the first recipient, which is supposed to be kept secret.

The foregoing description is given for clearness of understanding only, and no unnecessary limitations should be understood therefrom, as modifications within the scope of the disclosure may be apparent to those having ordinary skill in the art.

1. A method for dispatching postal parcels comprising the following steps:
(a) inputting a delivery address for the delivery of the postal parcels;
(b) changing at least one of (i) the delivery address according to a routine predefined by the recipient, and (ii) the delivery address as a function of free compartments of at least one parcel compartment system; and,
(c) delivering the postal parcels to the changed delivery address.

2. The method of claim 1, further comprising assigning a recipient identification code to a recipient, wherein the code is linked to the delivery address.

3. The method of claim 1, comprising carrying out the delivery step (c) as a function of data contained in a table.
